(19) United States
(12) Patent Application Publication
(10) Pub. No.: US 2002/0087426 A1
(43) Pub. Date: Jul. 4, 2002

(54) Online shopping method and system

(75) Inventors: Shuichi Shiitani, Kanagawa (JP); Susumu Endo, Kanagawa (JP); Naoki Sashida, Kanagawa (JP); Yusuke Uehara, Kanagawa (JP); Daiki Masumoto, Kanagawa (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 09/839,141

(22) Filed: Apr. 23, 2001

(30) Foreign Application Priority Data
Dec. 28, 2000 (JP) 2000-403214

(51) Int. Cl. G06F 17/60

(52) U.S. Cl. 705/26

(57) ABSTRACT

An article picture is previously obtained through an information obtaining part, and a data sending rank setting part sets a sending rank showing a sending priority. A picture feature analyzing part extracts picture features and stores article data in an article data storing part. When search conditions are input, an article search processing part conducts a search. Search results are given to an article picture arrangement data generating part, and article picture arrangement data is given to a data sending control part. Under the control of a sending order by the data sending control part, each article picture data is sent to a user terminal in accordance with a sending rank, and displayed at an arrangement position on a screen of search results in accordance with the sending rank.

### BACKGROUND OF THE INVENTION

1. Field of the Invention

The present invention relates to an online shopping method and system for a user to search for and purchase an intended article from a number of articles utilizing a user terminal connected online.

2. Description of the Related Art

Depending upon the kind of articles such as fashion products (e.g., clothes, small articles, etc.), the design such as a shape and a color of an article is important. Therefore, a user often determines to purchase an article, considering the design thereof. In purchasing an article, it is very important to check the outer appearance of the article as well as the function, quality, and price thereof.

At a conventional online shopping site in which a user searches for and purchases an intended article from a number of articles by utilizing a user terminal connected online, target articles are generally narrowed down by a keyword search and a category search. In most cases, a list of search results merely shows minimum information such as an article name and a price, and a link to a page displaying an article. In order to see a picture of the article so as to confirm the outer appearance thereof, it is required to access a homepage that allows a picture of each article to be browsed through. This will take a lot of time and trouble.

Conventionally, there is also a technique in which thumnail pictures of articles are displayed as search results. In this case, a user can select an article by checking the picture thereof.

However, according to a conventional online shopping method, although thumnail pictures of articles are displayed as search results, article pictures as search results are sorted according to a matching degree with a search keyword, arranged in the order of a list of an article database, etc. Therefore, articles similar to each other in outer appearance are not necessarily arranged at close positions. For example, in the case where there is an appealing article and a user wants to see another article similar to the appealing article in outer appearance in the search results, it is required to check all the displayed thumnail pictures of the search results. If the number of displayed thumnail pictures is large, it is difficult for a user to search for another article similar to the appealing article. Therefore, a user gives up purchasing a desired article or cannot help compromising on another article.

Furthermore, in the case where the number of articles hit as search results is large, it takes a long time to transmit/receive thumbnail picture data on the network. When a search screen is displayed after all the receiving data are collected at a user terminal, a user has to wait for a long period of time to feel inconvenience. Furthermore, even if thumnail pictures are displayed as they are successively received at a user terminal, the thumnail pictures are sorted in accordance with a search keyword or displayed in the order of a list of an article database. Therefore, the thumbnail pictures are not necessarily displayed in the order preferable for a user.

On the other hand, it would be advantageous for a service provider in terms of article sales to prevent a user from feeling stress caused by a waiting time and to rank articles for promotion of article sales while considering a sales strategy, thereby allowing a user to see an article picture for a longer period of time in accordance with the ranking.

### SUMMARY OF THE INVENTION

Therefore, with the foregoing in mind, it is an object of the present invention to provide an online shopping method and system that are capable of presenting article search results in such a manner that a user can easily find article pictures similar to each other in features such as an outer appearance, and displaying an easy-to-see screen of search results.

Another object of the present invention is to provide an online shopping method and system that are capable of displaying a search screen in such a manner that a user's waiting time is shortened, and article pictures are displayed in the order preferable for a user or a service provider.

In order to achieve the above-mentioned objects, the online shopping method of the present invention includes: previously generating/preparing article data in which features of an article and a data sending rank are related to each article picture as additional information; upon receiving an article search by a user, generating article picture arrangement data in which article pictures similar to each other in the features are disposed at close positions, as search results of the article data; sending the article picture arrangement data to a user terminal so that each article picture data is successively sent in accordance with the data sending rank; and at the user terminal, displaying each article picture data at each arrangement position on a screen of search results in a receiving order, thereby displaying an article picture with a higher data sending rank earlier at the arrangement position.

It is preferable that the features of the article are any one selected from the group consisting of features of an article picture of the article, a keyword representing the features of the article, and article classification information regarding classification of the article in accordance with the features thereof, or a combination thereof.

Because of the above-mentioned method, an article picture arrangement can be presented as article search results, in which article pictures similar to each other in classification features of an article group are disposed at close positions by using features of an article picture such as an outer appearance of an article, features of an article represented by a keyword, and a feature template for classifying articles into article groups in accordance with the features thereof. Furthermore, each article picture data is successively sent in accordance with a data sending rank and an article picture is displayed in a receiving order at a user terminal. Therefore, a user's waiting time can be shortened and article pictures can be displayed in the order preferable for a service provider.

If an article provider determines a data sending rank regarding a display order of article pictures at the user terminal, the article pictures can be displayed in the order preferable for the article provider.

Furthermore, if a service user previously selects items to be considered in purchasing an article and notifies a service provider of the selection, and the service provider determines the data sending rank in accordance with the notified items, the article pictures can be displayed in the order preferable for the service user.

Furthermore, if a service provider previously analyzes items considered by a service user based on a past search history and a past purchase history of the service user, and the service provider determines the data sending rank in accordance with the analyzed items, the article pictures can be displayed in the order preferable for the service user.

Furthermore, the online shopping method of the present invention includes, in a case where there is an article whose article picture cannot be prepared by an article provider, allowing the article provider to rent an article picture of the article or a similar article prepared by another article provider; and paying a license fee to an entity having a right to the rented article picture.

Because of the above-mentioned configuration, a business model can be provided, in which an article provider can flexibly provide an article picture of an article whose picture cannot be prepared by the article provider, and an article picture provider can obtain a reasonable license fee.

Furthermore, as described above, in the case where there is an article whose article picture cannot be prepared by an article provider, the article provider is allowed to rent an article picture. Alternatively, a representative article picture representing articles belonging to an article group is prepared, and the representative article picture is used as an article picture of the article.

Furthermore, it is also preferable that the representative article picture is used as a representative of the articles belonging to the article group, the representative article picture is disposed on a display of a user terminal so as to be presented to the user; and the articles belonging to the article group are displayed by the use of a pull-down menu of the representative article picture.

Because of the above-mentioned configuration, in the case where the search results contain a large number of articles, the number of article pictures to be displayed is decreased by displaying a representative picture, instead of reducing article pictures in size, which makes it easy to see a screen of search results at a user terminal.

Furthermore, in the above-mentioned configuration, it is preferable that a screen of article search results is presented to an article provider, and the article provider specifies a picture of an article which the article provider provides on the presented screen of article search results, thereby making it possible to access selling information of the article.

Because of the above-mentioned configuration, the relationship between the picture features and the selling state can be easily checked, and the tendency of a design of selling articles can be analyzed.

The online shopping system of the present invention can be configured using a computer by reading a processing program from a computer-readable recording medium storing processing operations for realizing the above-mentioned online shopping system.

These and other advantages of the present invention will become apparent to those skilled in the art upon reading and understanding the following detailed description with reference to the accompanying figures.

### BRIEF DESCRIPTION OF THE DRAWINGS

FIG. 1 shows an outline of a configuration of online shopping service of Embodiment 1 according to the present invention and a processing flow thereof.

FIG. 2 shows an exemplary arrangement of two-dimensionally disposed article pictures created by an article picture arrangement data creating part.

FIG. 3 schematically shows a state where article pictures are being arranged on a display of a user terminal.

FIG. 4 shows an outline of a configuration of online shopping service of Embodiment 2 according to the present invention and a processing flow thereof.

FIG. 5 shows an outline of a configuration of online shopping service of Embodiment 3 according to the present invention and a processing flow thereof.

FIG. 6 schematically shows a processing flow in the case where an article picture is rented in the configuration of Embodiment 4.

FIG. 7 shows an outline of a configuration of online shopping service of Embodiment 6 according to the present invention and a processing flow thereof.

FIG. 8 shows examples of recording media storing a processing program for realizing online shopping service of the present invention.

### DESCRIPTION OF THE PREFERRED EMBODIMENTS

### Embodiment 1

Hereinafter, an online shopping method and system of Embodiment 1 according to the present invention will be described.

According to the online shopping method and system of Embodiment 1, a service providing system previously receives an article picture of each article from an article provider, and generates/prepares article data in which picture features extracted from each article picture and a data sending rank assigned to each article are related to each article picture as additional information. Upon receiving an article search by a user, the service providing system generates, as search results of article data, article picture arrangement data in which article pictures similar to each other in features are disposed at close positions. Then, the article picture arrangement data is sent to a user terminal so that each article picture data is successively sent in accordance with the data sending rank. At the user terminal, each article picture data is displayed at each arrangement position on a screen of search results in a receiving order, whereby an article picture with a higher data sending rank is displayed earlier at the arrangement position.

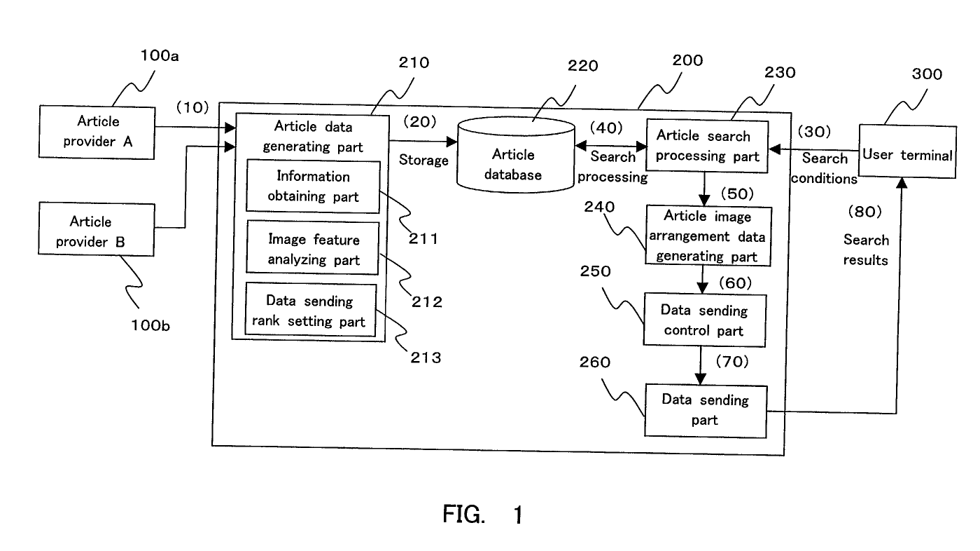

FIG. 1 shows an outline of a configuration of the online shopping service of Embodiment 1 and a processing flow thereof.

Reference numeral 100 denotes an article providing terminal. At an online shopping site, a number of article providers are likely to provide articles. In this example, a terminal 100a of an article provider A and a terminal 100b of an article provider B are shown. The article provider may be the same entity as that of an online shopping service provider.

Reference numeral 200 denotes an online shopping service providing system. The service providing system 200 includes an article data generating part 210, an article database 220, an article search processing part 230, an article picture arrangement data generating part 240, a data sending control part 250, and a data sending part 260.

The article data generating part 210 includes an information obtaining part 211, a picture feature analyzing part 212, and a data sending rank setting part 213.

The information obtaining part 211 obtains an article picture and article information of each article. For example, the information obtaining part 211 obtains information on a price, quality and a manufacturer of an article, as well as article picture data, from the article provider 100.

The picture feature analyzing part 212 analyzes an input article picture to extract feature data of the picture. For example, a plurality of picture features such as a color and a shape are extracted by a picture processing technique, and respectively converted into vector data.

The data sending rank setting part 213 sets a data sending rank showing an article picture sending priority in sending article picture arrangement data. There are a plurality of methods for setting a data sending rank by the data sending rank setting part 213. The method for setting a data sending rank of Embodiment 1 is determined by a service user. The service user previously selects items to be considered in purchasing an article and notifies the service provider 100 of them. The data sending rank setting part 213 determines a data sending rank in accordance with the notified items. An article group corresponding to the contents of the specified item may be provided with a priority flag. If a data sending rank is determined based on the items considered by the service user, each article picture is sent in accordance with the sending rank determined by the instruction of the service user. Then, each article picture can be displayed at each arrangement position at a user terminal 300 in a receiving order. Accordingly, article pictures can be displayed in the order preferable for the service user.

The data sending rank setting part 213 holds item data considered by the service user and analyses the items on a purchaser basis during an article search. The item data may be sent from the user terminal 300 during a search or may be stored in the service providing system 200, with a user ID attached thereto.

The article data generating part 210 generates/prepares article data in which picture features extracted from each article picture and a data sending rank assigned to each article are related to each article picture as additional information.

The article database 220 stores article data generated by the article data generating part 210.

The article search processing part 230 executes an article search using the article database 220 in accordance with the search conditions obtained from the user terminal 300.

The article picture arrangement data generating part 240 generates display picture data to be presented on a display of the user terminal 300, as article search processing results of the article search processing part 230. In this example, the article picture arrangement data generating part 240 generates article picture arrangement data in which article pictures similar to each other in features are disposed at close positions.

In sending the article picture arrangement data to the user terminal 300, the data sending control part 250 controls a sending order of each article picture data contained in the article picture arrangement data so that each article picture data is sent in accordance with its data sending rank. More specifically, the data sending control part 250 controls a sending order so that each article picture data with a higher data sending rank is sent earlier.

The data sending part 260 follows the control of the data sending control part 250, and sends article picture data with a higher data sending rank earlier to the user terminal 300.

The user terminal 300 is provided with an input/output interface for inputting a search request and requesting article purchase, and a display apparatus for displaying search results.

A processing flow of the online shopping service shown in FIG. 1 is outlined as follows.

First, the article provider 100 previously gives information on an article to be sold and an article picture used for displaying search results to the online shopping service providing system 200. The service providing system 200 obtains the article picture and other article information through the information obtaining part 211 (10). Any article picture may be used. However, an article picture of higher quality can be provided by specifying conditions for capturing an article so that picture features are easily extracted in an automatic manner.

Furthermore, in Embodiment 1, a user uses the data sending rank setting part 213 to previously set a sending rank showing a sending priority of article picture data in sending article picture arrangement data, on an particle basis or on an article group basis.

The service providing system 200 that has received information on an article and an article picture extracts picture features using the picture feature analyzing part 212.

The service providing system 200 uses the article data generating part 210 to generate article data in which picture features extracted from each article picture and a data sending rank assigned to each article are related to each article picture as additional information, and stores each generated article data in the article database 220 (20).

It is preferable that the above-mentioned processings (10) and (20) are conducted as preprocessing for a search by the service user.

Next, a user inputs article search conditions such as desires for an article through the user terminal 300 (30). Examples of a search method include a keyword search and a category search. According to the keyword search, an article is selected by inputting a keyword, whereas according to the category search, an intended article is selected from a previously prepared category.

The article search processing part 230 conducts an article search using the article database 220 under the search conditions obtained from the user terminal 300 (40). The article search processing part 230 lists search results of the articles corresponding to the keyword or category, and gives them to the article picture arrangement data generating part 240 (50).

The article picture arrangement data generating part 240 refers to picture feature data of article pictures of the listed articles, generates article picture arrangement data arranged two-dimensionally in accordance with the picture features, and gives it to the data sending control part 250 (60). The article picture arrangement data contains, for example, a picture ID and arrangement coordinate data.

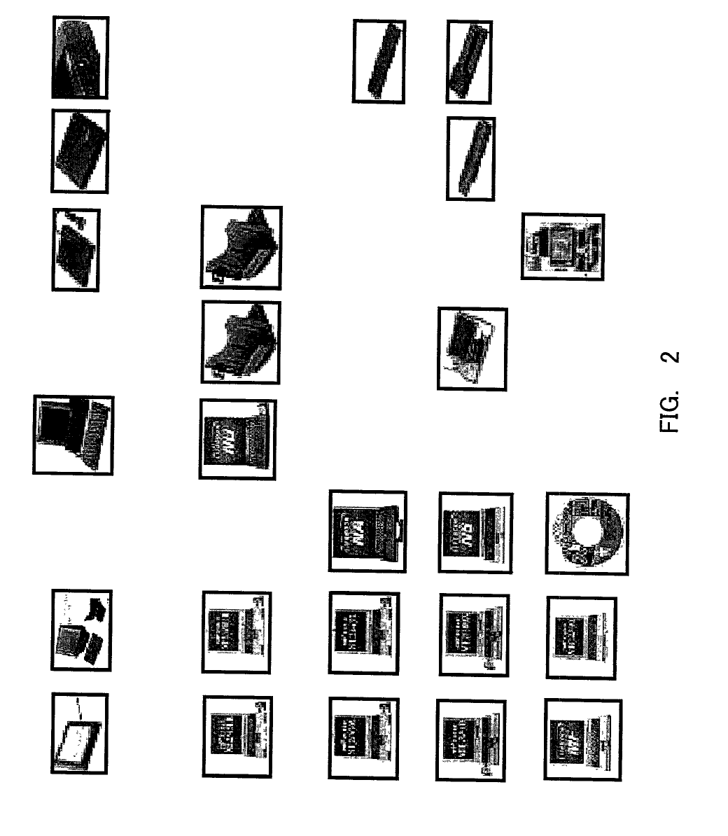

FIG. 2 shows an exemplary arrangement of two-dimensionally disposed article pictures created by the article picture arrangement data generating part 240. FIG. 2 shows exemplary results of searching for personal computer related articles. For example, the article pictures are arranged in accordance with picture features such as a picture shape and a color, and article attributes such as a manufacturer and a price.

The generated article picture arrangement data is sent to the user terminal 300 as search results. The amount of article picture arrangement data is large if it contains a large amount of picture data; therefore, the data sending control part 250 controls a sending order of each article picture data so that it is sent in accordance with its additional information (i.e., sending rank information). Under the control of a sending order by the data sending control part 250 (70), the data sending part 260 sends each article picture data to the user terminal 300 in accordance with its sending rank (80).

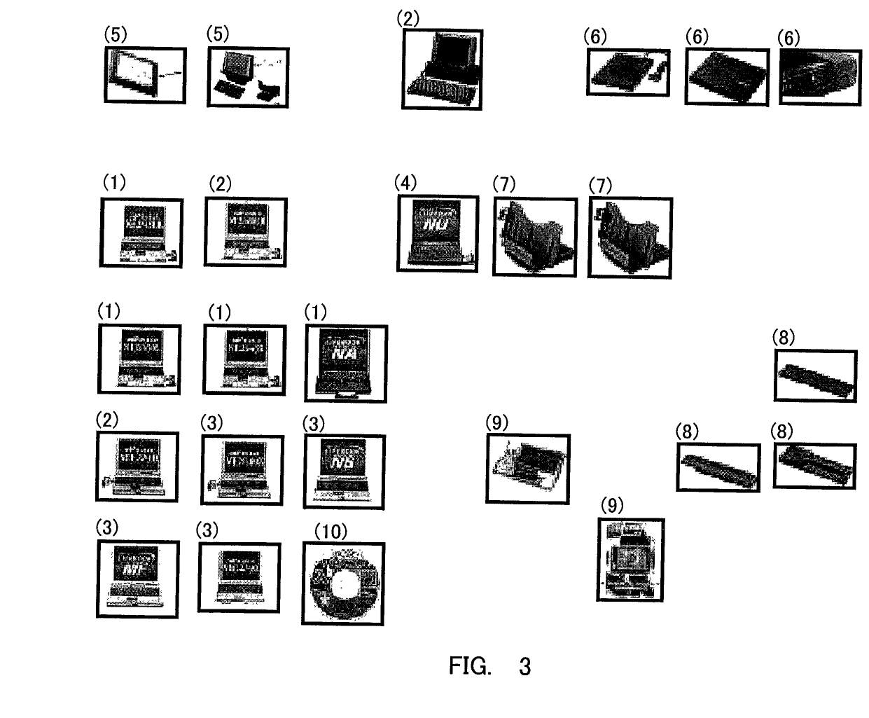

The user terminal 300 receives each article picture data, and displays it at each arrangement position on a screen of search results in a receiving order. An arrangement data table is referred to, based the arrangement coordinate data and a picture ID in the received data, whereby article picture data is disposed at a predetermined display position. Each article picture may be displayed successively. Alternatively, a plurality of article pictures are considered as a unified article picture group in the same rank, based on the data sending capacity and data processing speed, and they may be displayed simultaneously. FIG. 3 schematically shows a state where articles pictures are being successively arranged in accordance with the data sending rank on a display of the user terminal 300. (1), (2), (3), . . . refer to display orders. In the example shown in FIG. 3, a plurality of pictures are simultaneously displayed as a unified article picture group in the same rank. For example, a plurality of pictures denoted with (1) are displayed as a unified group, and then, a plurality of pictures denoted with (2) are displayed as a unified group.

In an initial arrangement, pictures are listed in accordance with certain features. Thereafter, a user can input features of pictures and change the initial arrangement to another picture arrangement in accordance with such features. A user operates an input/output interface to purchase an intended article.

As described above, according to the online shopping method and apparatus of Embodiment 1, a list of pictures arranged so that article pictures similar to each other are disposed at close positions can be presented to a purchaser as search results, and an article can be selected mainly based on a design. This enables a purchaser to easily attain an intended article with a high probability, whereby more convenient online shopping service can be provided. Furthermore, because of the above-mentioned control of data processing, article pictures with a higher sending rank are displayed earlier at arrangement positions on a display of a user terminal in accordance with the data sending rank determined by a user. This shortens a waiting time, so that a user can start selecting an article before all the picture data are read.

### Embodiment 2

Hereinafter, an online shopping method and system of Embodiment 2 according to the present invention will be described.

According to the online shopping method and system of Embodiment 2, a service providing system previously receives an article picture of each article from an article provider, and generates/prepares article data in which a keyword representing features of each article and a data sending rank assigned to each article are related to each article picture as additional information. Upon receiving an article search by a user, the service providing system generates, as search results of article data, article picture arrangement data in which article pictures similar to each other in features represented by the keyword are disposed at close positions on a display of a user terminal. Then, the article picture arrangement data is sent to the user terminal so that each article picture data is successively sent in accordance with the data sending rank. At the user terminal, each article picture data is displayed at each arrangement position on a screen of search results in a receiving order, whereby an article picture with a higher data sending rank is displayed earlier at the arrangement position.

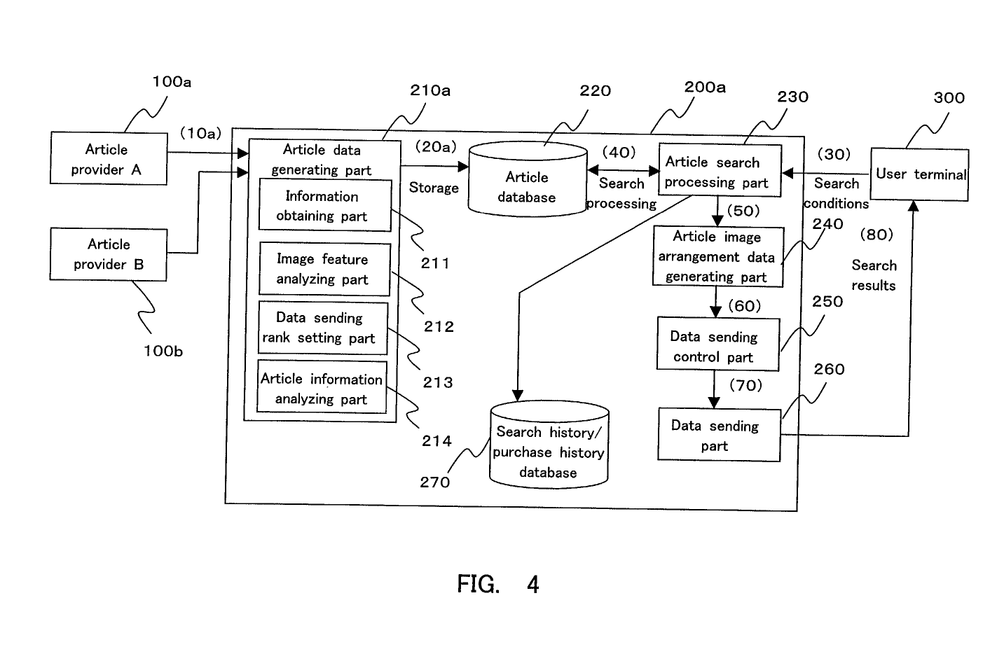

FIG. 4 shows an outline of a configuration of the online shopping service of Embodiment 2 and a processing flow thereof.

According to the configuration of Embodiment 2 shown in FIG. 4, compared with the configuration of Embodiment 1 shown in FIG. 1, an online shopping service providing system 200a further includes an article information analyzing part 214 in an article data generating part 210a, and further includes a search history/purchase history database 270. The other components such as the article database 220, the article search processing part 230, the article picture arrangement data generating part 240, the data sending control part 250, and the data sending part 260 are the same as those in Embodiment 1. Therefore, the description thereof will be omitted here.

First, the article provider 100 previously gives information on an article to be sold and an article picture used for displaying search results to the online shopping service providing system 200a. The service providing system 200a obtains the article picture and other article information through the information obtaining part 211 (10a). At this time, the article provider 100 also provides text information that is a keyword describing article features as a part of article information. This text may be arbitrarily described by the article provider 100, or may provide conditions so that the online shopping service provider can easily analyze the article search by service users.

In Embodiment 2, in addition to the extraction of picture features in Embodiment 1 shown in FIG. 1, the article information analyzing part 214 analyzes a keyword given as a part of the article information, thereby extracting picture features and article features.

In Embodiment 2, a sending rank of article picture data is set by the data sending rank setting part 213 as follows: items considered by a service user are analyzed based on a past search history and a past purchase history of the service user, and a data sending rank is determined in accordance with the analyzed items. Furthermore, a particular article group may be provided with a priority flag based on the past history. If a data sending rank is determined in accordance with the items considered by the service user based on the past search history and the past purchase history of the service user, each article picture is sent in accordance with the sending rank determined based on the items considered by the service user. Then, each article picture can be displayed at each arrangement position at the user terminal 300 in a receiving order. Accordingly, article pictures can be displayed in the order preferable for the service user. For this purpose, the data sending rank setting part 213 in FIG. 4 can access the search history/purchase history database 270. The search history/purchase history database 270 holds the past search history data and purchase history data on a service user basis, and stores data every time a use history by the service user occurs.

The data sending rank setting part 213 analyzes and holds item data considered by a user based on the purchase history. The item data may be sent from the user terminal 300 during a search or may be stored in the service providing system 200a, with a user ID attached thereto.

The service providing system 200a uses the article data generating part 210a to generate article data in which article features extracted from a keyword and a data sending rank assigned to each article are related to each article picture data as additional information, and stores each generated article data in the article database 220 (20a).

The processing after the article search processing (30) by a user through the user terminal 300 may be the same as that in Embodiment 1. Therefore, the description thereof will be omitted here. However, a data sending rank is determined in accordance with items considered by a service user in purchasing an article, so that each article picture is sent in accordance with such a sending rank, and displayed at an arrangement position at the user terminal 300 in a receiving order.

As described above, according to the online shopping method and apparatus of Embodiment 2, in the same way as in Embodiment 1, a list of pictures arranged so that article pictures similar to each other are disposed at close positions can be presented to a purchaser as search results. Furthermore, a list of pictures can be arranged based on information containing article features that do not appear in a picture. Furthermore, at the user terminal, an article picture with a higher sending rank is displayed earlier at an arrangement position on a display of the user terminal. This shortens a waiting time, and a user can start selecting an article before all the picture data are read.

### Embodiment 3

Hereinafter, an online shopping method and system of Embodiment 3 according to the present invention will be described.

According to the online shopping method and system of Embodiment 3, a service providing system previously receives an article picture of each article from an article provider, and generates/prepares article data in which classification of articles based on features thereof and a data sending rank assigned to each article are related to each article picture as additional information. Upon receiving an article search by a user, the service providing system generates, as search results of article data, article picture arrangement data in which article pictures belonging to the same article group are disposed at close positions on a display of a user terminal. Then, the article picture arrangement data is sent to the user terminal so that each article picture data is successively sent in accordance with the data sending rank. At the user terminal, each article picture data is displayed at each arrangement position on a screen of search results in a receiving order, whereby an article picture with a higher data sending rank is displayed earlier at the arrangement position.

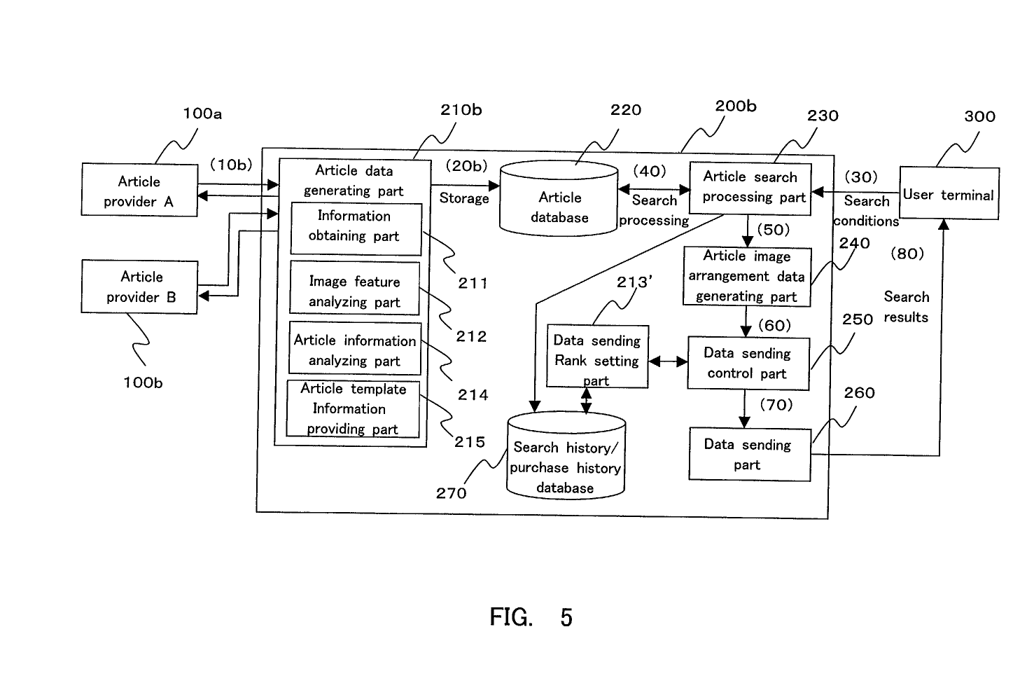

FIG. 5 shows an outline of a configuration of the online shopping service of Embodiment 3 and a processing flow thereof.

According to the configuration of Embodiment 3 shown in FIG. 5, unlike the configuration of Embodiment 2 shown in FIG. 2, in an online shopping service providing system 200b, a data sending rank setting part 213′ is not disposed in an article data generating part 210b, but provided so as to access the data sending control part 250 and the search history/purchase history database 270. Furthermore, an article template information providing part 215 is added to the article data generating part 210b. The other components such as the article database 220, the article search processing part 230, the article picture arrangement data generating part 240, the data sending control part 250, the data sending part 260, and the search history/purchase history database 270 are the same as those in Embodiment 1 or 2. Therefore, the description thereof will be omitted here.

First, the article provider 100 previously gives information on an article to be sold and an article picture used for displaying search results to the online shopping service providing system 200b. The service providing system 200b obtains the article picture and other article information through the information obtaining part 211 (10b). At this time, the article provider 100 checks article template information presented by the article template information providing part 215, selects a template suitable for the article, and provides article information in accordance with the article template as a part of article information. For this purpose, the online shopping service provider prepares a template for describing features of an article with respect to the article provider 100. For example, the service provider prepares a plurality of selections on an item basis, such as a color, a shape, and a material. In the case of a color, selections such as deep sky blue, sky blue, and light sky blue are prepared. It is preferable that similarity is previously set in the selections.

In addition to the extraction of picture features in Embodiment 1 shown in FIG. 1, the service providing terminal 200b uses the article information analyzing part 214 to analyze article information input in accordance with an article template, given as a part of article information, and extract features of an article.

Furthermore, the service providing terminal 200b sets a sending rank showing a sending priority of article picture data in sending article picture arrangement data through the data sending rank setting part 231′. In Embodiment 3, a sending rank is set by the article provider 100. The article provider 100 determines a data sending rank on an article basis or on an article group basis. If a data sending rank is determined based on a sales strategy of the article provider 100, each article picture is sent so that articles which the article provider 100 desires to advertise most are sent preferentially. Then, each article picture can be displayed at each arrangement position at the user terminal 300 in a receiving order. Accordingly, article pictures can be displayed in the order preferable for the article provider 100. For this purpose, the data sending rank setting part 213′ in FIG. 5 can access the search history/purchase history database 270. The search history/purchase history database 270 holds the past search history data and purchase history data on a service user basis, and stores data every time a use history by the service user occurs.

The processing after the article search processing (30) by a user through the user terminal 300 may be the same as that in Embodiment 1. Therefore, the description thereof will be omitted here. However, a data sending rank is determined in accordance with the ranking determined by the article provider 100, so that each article picture is sent in accordance with such a sending rank, and displayed at an arrangement position at the user terminal 300 in a receiving order.

As described above, according to the online shopping method and apparatus of Embodiment 3, in the same way as in Embodiment 1, a list of pictures arranged so that article pictures similar to each other are disposed at close positions can be presented to a purchaser as search results. Furthermore, article information organized on the basis of an item of an article template can be added, so that a list of pictures can be more correctly arranged. Furthermore, at the user terminal, an article picture with a higher sending rank is displayed earlier at an arrangement position on a display of the user terminal. This shortens a waiting time, and a user can start selecting an article before all the picture data are read.

### Embodiment 4

Hereinafter, an online shopping method and system of Embodiment 4 according to the present invention will be described.

The online shopping method and system of Embodiment 4 realize a business model as follows: in the case where there is an article whose article picture cannot be previously obtained from an article provider, the article provider is allowed to rent an article picture created by a third party, and an entity that has the right to the article picture obtains a license fee thereof.

Due to the widespread use of digital cameras, anybody can easily capture pictures to convert them to digital data. However, in order to capture an article picture of such high quality as to arouse a desire of customers for purchasing the article, some technique is required. Therefore, all the article providers cannot prepare pictures of their articles. It would be convenient for an article provider to use a picture of an article provided by another article provider, if the article of the article provider is the same or similar to that of another article provider. The online shopping method and system of Embodiment 4 brokers rental of an article picture. When license is obtained from an entity having the right to an article picture, the article picture is allowed to be used as a picture at an online shopping site, and an article provider that rents the article picture pays a license fee to the entity having the right to the article picture. It is preferable that the online shopping method and system of Embodiment 4 also broker paying/receiving a license fee. Regarding rental of an article picture, an entity having the right to an article picture may be inquired about rental possibility in each case. Alternatively, an entity may previously select an article picture to be licensed.

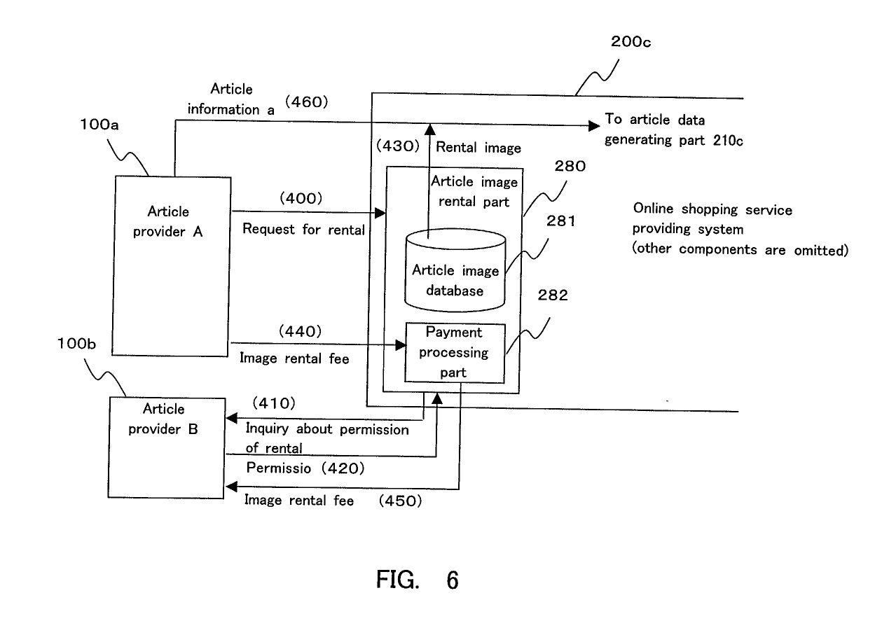

FIG. 6 schematically shows a processing flow in the case where an article picture is rented in the configuration of Embodiment 4. In this example, an article provider A rents an article picture “a” from an article provider B. A service providing system 200c includes an article picture rental part 280. The article picture rental part 280 includes an article picture database 281 and a payment processing part 282. In the online shopping method and system of Embodiment 4, an article picture of each article is arranged on a display of a user terminal so as to be presented to a user as article search results. However, the online shopping method and system of Embodiment 4 may be combined with the configurations of Embodiments 1 to 3 to include the article data generating part 210, the article database 220, the article search processing part 230, the article picture arrangement data generating part 240, the data sending control part 250, the data sending part 260, and the like.

The article picture rental part 280 brokers rental of an article picture. The article picture database 281 stores article pictures provided by article providers and the like. In this example, it is assumed that the article picture “a” of the article provider B (100b) is contained in the article picture database 281. The article picture database 281 preferably has functions of classifying article pictures in accordance with the category and attributes of articles so as to present a list in accordance with the request of an entity that desires to rent an article picture, receiving a selection of an article picture desired for rental, and inquiring an entity having the right to such an article picture about permission of rental.

The payment processing part 282 brokers payment of a license fee involved in rental of an article picture.

FIG. 6 shows an outline of a processing flow in the case where an article picture is rented.

It is assumed that the article provider A (100a) is required to present the article picture “a” so as to sell an article A, and the article picture “a” is owned by the article provider B, not by the article provider A.

As described in Embodiments 1 to 3, in general, the article provider A (100a) gives article information on an article to be sold and the article picture “a” for displaying search results to the online shopping service providing system 200c. However, the article provider A (100a) does not have the article picture “a”, so that it requests rental of the article picture “a” with respect to the article picture rental part 280 (400). The article provider A requests a search using, for example, an article name, an article category, article attributes, and the like as a key.

The article picture rental part 280 first presents a list of article pictures stored in the article picture database 281 to the article provider A (100a). Then, the article provider A selects an article picture (in this example, the article picture “a”) which it desires to rent from a list of article pictures, and notifies the article picture rental part 280 of the selected article picture “a”.

The article picture rental part 280 receives the selection of the article picture “a”, and inquires the article provider B having the right to the article picture “a” about permission of rental (410). At this time, the article picture rental part 280 may notify the article provider B of payment conditions involved in rental of the article picture “a”.

The article provider B answers whether or not rental is permitted (420). In this example, it is assumed that rental of a picture is permitted. In addition, the article provider B may sign a contract regarding payment involved in rental of the article picture “a”.

The article picture rental part 280 allows the article provider A to rent the article picture “a” (430).

After allowing the article provider A to rent the article picture “a”, the article picture rental part 280 brokers payment of a license fee in each case or at a payment period by using the payment processing part 282. First, the article picture rental part 280 notifies the article provider A of a request for payment of a license fee involved in rental of the article picture “a”. The article provider A pays a determined amount of payment to the payment processing part 282 in accordance with a predetermined payment method (440).

The payment processing part 282 brokers payment of a license fee involved in rental of the article picture “a” to the article provider B (450). At this time, the service providing system 200c may pay a license fee to the article provider B with a commission for rental of picture subtracted.

The article provider A gives required article information to the service providing system 200c (460), so that the processings (10, 10a, 10b) described in Embodiments 1 to 3 are conducted. The article information given by the article provider A is provided with information of the rented article picture “a” (picture itself or a link to the picture) (430). In the service providing system 200c, for example as described in Embodiment 1, article data is generated in the article data generating part 210, and the subsequent processing is conducted.

In the above description, the case is described in which an entity providing an article picture is an article provider. However, the entity providing an article picture is not limited to an article provider, and may be any entity having the right to the article picture. For example, the entity providing an article picture may be an entity that is specialized in providing article pictures without providing articles.

As described above, the online shopping method and system of Embodiment 4 can broker rental of an article picture. An entity that rents an article picture can reduce a cost for creating a picture, and an entity that provides an article picture for rental receives a license fee involved in rental thereof.

### Embodiment 5

Hereinafter, an online shopping method and system of Embodiment 5 according to the present invention will be described.

According to the online shopping method and system of Embodiment 5, in the case where there is an article whose article picture cannot be previously obtained from an article provider, the service providing system prepares a representative article picture on an article basis or on an article group basis, and the representative article picture is used as an article picture of an article to be sold.

It is preferable to prepare a representative article picture so that a concept of a particular article or a particular article group can be understood. A representative article picture may be selected from article pictures to which the service providing system has the right. Alternatively, the business model as in Embodiment 4 may be adopted in which an article picture owned by a third party is rented as a representative article picture, and a license fee involved in rental is paid.

Furthermore, in the case of using a representative picture, the following can be conducted.

A representative picture may be used on an article group basis as described above. Therefore, in the case where there are a number of article providers, article providing service of the same kind may be conducted. In this case, it is assumed that a plurality of the same representative pictures are used. If the same representative pictures are used individually, a number of the same representative pictures are arranged as a list of search results at the user terminal. Since they are the same representative pictures, picture features are also the same; consequently, arrangement positions thereof are concentrated, which are difficult to see.

If a representative article picture is used for articles belonging to an article group, and the representative article picture is disposed as a representative of the article group, a number of the same representative pictures can be prevented from being arranged. Furthermore, if a pull-down menu is assigned to a representative article picture so as to be displayed on a display of the user terminal 300, for the purpose of allowing articles commonly represented by the representative article picture to be browsed through individually, information on the articles commonly represented by the representative article picture can be displayed.

As described above, according to the online shopping method and system of Embodiment 5, by providing a representative article picture, article providing service can be conducted even in the case where individual article pictures cannot be prepared. Furthermore, if the representative article picture is disposed as a representative of a article group, a number of the same article pictures can be prevented from being arranged.

### Embodiment 6

Hereinafter, an online shopping method and system of Embodiment 6 according to the present invention will be described.

According to the online shopping method and system of Embodiment 6, an article provider can access selling information of articles by using the same screen as that of article search results presented to a user.

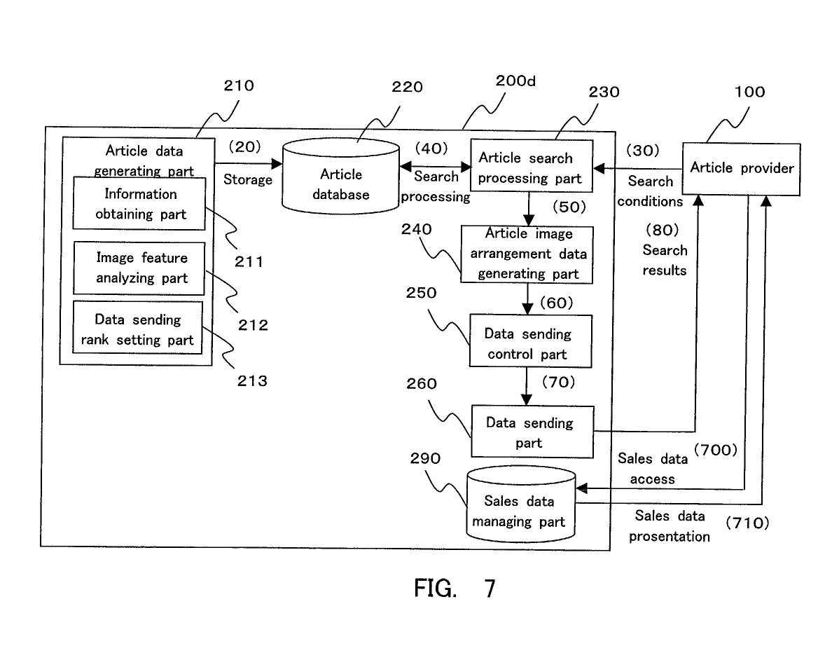

FIG. 7 shows an outline of a configuration of an online shopping service of Embodiment 6 and a processing flow thereof.

The configuration in FIG. 7 is based on the configuration of Embodiment 1 shown in FIG. 1 as an example. Compared with the configuration in FIG. 1, an online shopping service providing system 200d includes a sales data managing part 290. The other components such as the article database 220, the article search processing part 230, the article picture arrangement data generating part 240, the data sending control part 250, and the data sending part 260 are the same as those in Embodiment 1. Therefore, the description thereof will be omitted here.

In the same way as in the user terminal 300 shown in FIG. 1 and the like, the article provider 100 gives search conditions to the article search processing part 230 and receives article picture arrangement data generated by the article picture arrangement data generating part 240, and a screen of article search results is presented to the article provider 100. It is assumed that the screen to be displayed is the same as that is browsed through by a user. For example, the screen as shown in FIG. 2 is displayed. It is technically possible that an access state from the user terminal 300 is monitored in real time, instead of that an article provider conducts an article search. In this case, protection of privacy needs to be sufficiently considered. Furthermore, the configuration of Embodiment 3 as shown in FIG. 5 may be adopted in which the search history/purchase history database 270 is provided so as to store history information (regarding which operation a user has conducted, which article a user has purchased, etc.), and the same screen browsed through by a user is presented to the article provider 100 based on the history information.

As described above, when a list of article pictures is displayed on a display of the user terminal 300, the article provider 100 can also check how article pictures are arranged by browsing through the same search screen as that of a user.

The article provider 100 can also access the sales data managing part 290. The sales data managing part 290 responses an inquiry from the article provider 100 to present data showing a sales state of each article. More specifically, the article provider 100 can obtain sales data regarding which article is selling well. Furthermore, by using a search screen together, the article provider 100 can also conduct various analyses regarding the outer appearance and features of the articles selling well and the difference between the article of the article provider 100 and the articles selling well. Accordingly, it becomes easier for the article provider 100 to plan a sales strategy by analyzing the tendency of a design of selling articles.

Considering the security of sales data, it is preferable to provide a predetermined limit such as setting of an access authority level. It is also possible to charge for service of accessing sales data.

### Embodiment 7

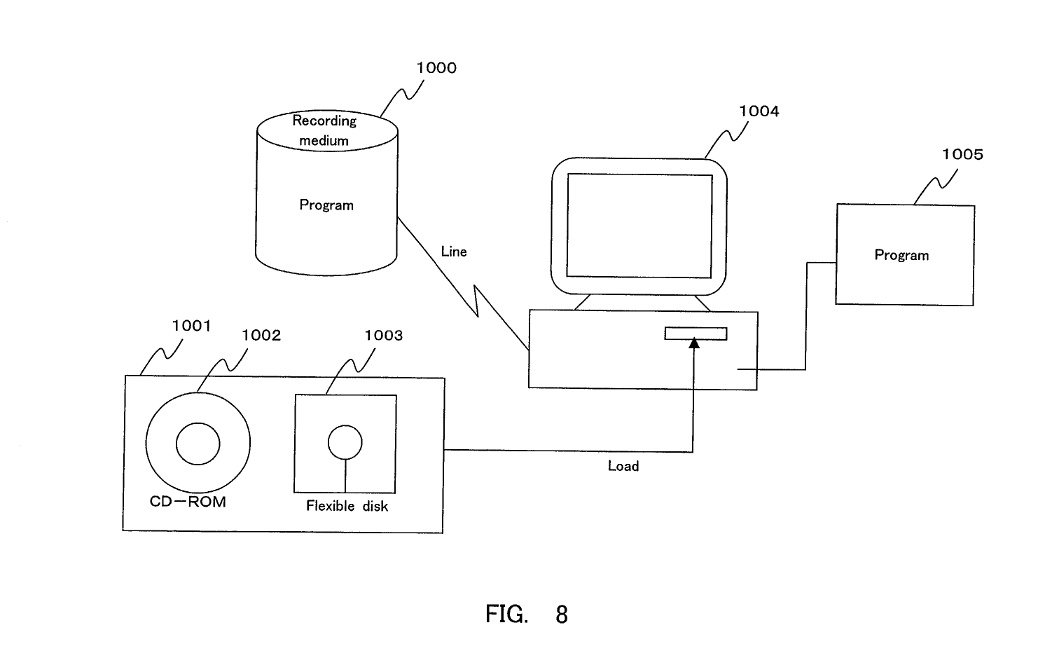

The online shopping system of the present invention can be configured using various computers by providing a computer-readable recording medium storing a program that describes processing operations for realizing the above-mentioned configuration. Examples of recording media storing a program including processing operations for realizing the online shopping system of the present invention include a recording medium 1000 in a recording apparatus on a network and a recording medium 1005 such as a hard disk and a RAM of a computer, as well as a portable recording medium 1001 such as a CD-ROM 1002 and a flexible disk 1003, as shown in FIG. 8. In execution, the program is loaded onto a computer 1004 and executed on a main memory.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. An online shopping method, comprising:
previously generating/preparing article data in which features of an article and a data sending rank are related to each article picture as additional information;
upon receiving an article search by a user, generating article picture arrangement data in which article pictures similar to each other in the features are disposed at close positions, as search results of the article data;
sending the article picture arrangement data to a user terminal so that each article picture data is successively sent in accordance with the data sending rank; and
at the user terminal, displaying each article picture data at each arrangement position on a screen of search results in a receiving order, thereby displaying an article picture with a higher data sending rank earlier at the arrangement position.

2. An online shopping method according to claim 1, wherein the features of the article are any one selected from the group consisting of features of an article picture of the article, a keyword representing the features of the article, and article classification information regarding classification of the article in accordance with the features thereof, or a combination thereof.

3. An online shopping method according to claim 2, wherein the data sending rank is determined by an article provider.

4. An online shopping method according to claim 2, wherein a service user previously selects items to be considered in purchasing an article and notifies a service provider of the selection, and
the service provider determines the data sending rank in accordance with the notified items.

5. An online shopping method according to claim 2, wherein a service provider previously analyzes items considered by a service user based on a past search history and a past purchase history of the service user, and
the service provider determines the data sending rank in accordance with the analyzed items.

6. An online shopping method according to claim 2, wherein a screen of article search results is presented to an article provider, and the article provider specifies a picture of an article which the article provider provides on the presented screen of article search results, thereby making it possible to access selling information of the article.

7. An online shopping method according to claim 1, wherein the data sending rank is determined by an article provider.

8. An online shopping method according to claim 1, wherein a service user previously selects items to be considered in purchasing an article and notifies a service provider of the selection, and
the service provider determines the data sending rank in accordance with the notified items.

9. An online shopping method according to claim 1, wherein a service provider previously analyzes items considered by a service user based on a past search history and a past purchase history of the service user, and
the service provider determines the data sending rank in accordance with the analyzed items.

10. An online shopping method according to claim 1, wherein a screen of article search results is presented to an article provider, and the article provider specifies a picture of an article which the article provider provides on the presented screen of article search results, thereby making it possible to access selling information of the article.

11. An online shopping method for allowing a user to search for an intended article from a number of articles and disposing an article picture of each article on a display of a user terminal so as to present it to a user as search results, comprising:
in a case where there is an article whose article picture cannot be prepared by an article provider, allowing the article provider to rent an article picture of the article or a similar article prepared by another article provider; and
paying a license fee to an entity having a right to the rented article picture.

12. An online shopping method according to claim 11, wherein a screen of article search results is presented to an article provider, and the article provider specifies a picture of an article which the article provider provides on the presented screen of article search results, thereby making it possible to access selling information of the article.

13. An online shopping method for allowing a user to search for an intended article from a number of articles and disposing an article picture of each article on a display of a user terminal so as to present it to a user as search results, comprising:
preparing a representative article picture representing articles belonging to an article group; and
in a case where there is an article whose article picture cannot be provided by an article provider, allowing the article provider to use the representative article picture as an article picture of the article.

14. An online shopping method according to claim 13, wherein a screen of article search results is presented to an article provider, and the article provider specifies a picture of an article which the article provider provides on the presented screen of article search results, thereby making it possible to access selling information of the article.

15. An online shopping method for allowing a user to search for an intended article from a number of articles and disposing an article picture of each article on a display of a user terminal so as to present it to a user as search results, comprising:
preparing a representative article picture representing articles belonging to an article group;
using the representative article picture as a representative of the articles belonging to the article group, and disposing the representative article picture on a display of a user terminal so as to present it to the user; and
allowing the articles belonging to the article group to be displayed by the use of a pull-down menu of the representative article picture.

16. An online shopping method according to claim 15, wherein a screen of article search results is presented to an article provider, and the article provider specifies a picture of an article which the article provider provides on the presented screen of article search results, thereby making it possible to access selling information of the article.

17. An online shopping system for a user to search for and purchase an intended article from a number of articles,
a service providing system comprising:
an article data generating part for previously generating/preparing article data in which features of the article and a data sending rank are related to each article picture as additional information;
an article database for storing the article data;
a search processing part for searching the article database upon receiving an article search by a user;
an article picture arrangement data generating part for receiving search results of the search processing part and generating article picture arrangement data in which article pictures similar to each other in the features are disposed at close positions; and
a data sending control part for sending the article picture arrangement data to a user terminal so that each article picture data is arranged and sent in accordance with the data sending rank information,
a user terminal comprising a display control part for displaying each article picture data at each arrangement position on a screen of search results in a receiving order,
wherein an article picture with a higher data sending rank is displayed earlier at an arrangement position at the user terminal.

18. An online shopping method according to claim 17, wherein the features of the article are any one selected from the group consisting of features of an article picture of the article, a keyword representing the features of the article, and article classification information regarding classification of the article in accordance with the features thereof, or a combination thereof.

19. A program for realizing an online shopping system for a user to search for and purchase an intended article from a number of articles, the program comprising:
previously generating/preparing article data in which features of an article and a data sending rank are related to each article picture as additional information;
upon receiving an article search by a user, generating article picture arrangement data in which article pictures similar to each other in the features are disposed at close positions, as search results of the article data;
sending the article picture arrangement data to a user terminal so that each article picture data is successively sent in accordance with the data sending rank; and
at the user terminal, displaying each article picture data at each arrangement position on a screen of search results in a receiving order, thereby displaying an article picture with a higher data sending rank earlier at the arrangement position.

20. A program according to claim 19, wherein the features of the article are any one selected from the group consisting of features of an article picture of the article, a keyword representing the features of the article, and article classification information regarding classification of the article in accordance with the features thereof, or a combination thereof.
